(19) United States
(12) Patent Application Publication
(10) Pub. No.: US 2004/0072118 A1
(43) Pub. Date: Apr. 15, 2004

(54) Lingual bracket

(76) Inventors: Wolfgang Heiser, Innsbruck (AT); Claus Schendell-Groling, Gilching (DE)

Correspondence Address: SUGHRUE MION, PLLC, 2100 PENNSYLVANIA AVENUE, N.W., SUITE 800, WASHINGTON, DC, 20037, US

(21) Appl. No.: 10/467,915

(22) PCT Filed: Feb. 14, 2002
(86) PCT No.: PCT/EP02/01568

(30) Foreign Application Priority Data
Feb. 14, 2001 (EP) 01 103 452.7

(51) Int. Cl. A61C 3/00

(52) U.S. Cl. 433/11

(57) ABSTRACT

A lingual bracket for orthodontic treatments in the anterior and canine tooth area comprises a slot directed in parallel to the base plate of the bracket, said slot being aligned in a manner that the slot opening points towards the chewing plane. The slot preferably has a depth that is lower than its width. As an element for securing an arch wire in the slot, said slot is preferably covered by a closing spring, which I stably held on the bracket frame in the opening and closing position. An arch wire inserted into the slot is pressed by the closing spring against the slot bottom and generates the forces on the bracket that are required for the tooth position correction. The use of safety lugs for the closing spring can be renounced, which reduces the height of the bracket.

### FIELD OF THE INVENTION

The present invention refers to a lingual bracket for orthodontic treatments of the upper and lower anterior and canine teeth, consisting of a base plate for the adhesive attachment to the lingual side of a tooth, said base plate having opposing occlusal and gingival edges and opposing mesial and distal edges, a frame elevated from the base plate, said frame having a slot extending substantially in parallel to the occlusal and gingival edges for receiving an arch wire and possibly with a means movably supported at the frame for at least partially covering the slot opening extending in parallel to said edges. A bracket of this kind is known from U.S. Pat. No. 4,698,017.

### BACKGROUND OF THE INVENTION

The teeth of the human denture may have various malalignments. To correct these malalignments, brackets are attached at the teeth, said brackets being connected with one another like pearls on a string by a resilien arch wire inserted into slots provided in the backets, said slots being formed differently depending on the tooth. Depending on the malalignment of the tooth, the arch wire produces different forces via the bracket at the respective tooth, said forces of different kind, being called “angulation”, “rotation” and “torque” due to the fact that the arch wire is also held by brackets on the other teeth. Angulational forces correct a lateral oblique positioning of the tooth, rotational forces rotate the tooth virtually around its axis and torque-forces pivot the tooth transversely to the row of teeth, i.e. around an axis extending transversely and substantially in parallel to the row of teeth, to correct for instance progenia, a cross bite or an overjet. In total, a three-dimensional correction of the position of each individual tooth takes place. The different correction directions will be explained later-on.

When treating dental malalignments by means of brackets, a relatively thin arch wire is initially used, since at first, low correction forces on the teeth are sufficient and too great correction forces would cause pain. At an increase of approximation of the teeth to the target position as a result of a progressing treatment success, thicker wires must increasingly be used to apply the required correction forces to the teeth. The arch wire is exchanged up to ten times during the entire treatment.

The cross-sectional dimensions of arch wires of a square or rectangular cross section are standardized in US-American magnitudes and reach from 16×16 mil to 22×28 mil (1 mil=10⁻³ inches). Accordingly, the bracket slots have dimensions that are sufficient for receiving the arch wire of the largest cross section which is provided for the treatment.

Prior Art

U.S. Pat. No. 5,863,199 describes a lingual orthodontic bracket, in which the means for covering or closing the slot provided for receiving the arch wire is a lever pivotally supported on the frame around a bearing pin, said lever having to be held by ligatures in its closing position, with the ligatures being wound around a lug formed on the frame. The slot is formed on the bracket in a manner that its opening points in the direction of the gingiva. That means that the orthodontist must insert the arch wire into the slot from the back side of the bracket. This can be supervised only indirectly by means of a mirror. Further, when biting into food the arch wire is subjected to the pressure of the respective food in a direction leading out of the slot so that the arch wire would be pressed out of the slot if said lever opened. Therefore, the ligatures must be extremely reliable to prevent opening of the closing means arranged above the slot.

A bracket is described in U.S. Pat. No. 5,857,849 which can be inserted both labially and lingually. It has a very flat frame in which the slot for receiving an arch wire points away from the base plate substantially perpendicularly. The slot is covered by a closing plate, which is held by a spring in a closing position. The disadvantage of this construction is that the pressure applied by the arch wire, which in the case of a lingual application of the bracket is frequently directed inwardly, i.e. in the direction of the oral cavity, must be received by the closing plate and by its spring holding the closing plate in the closing direction. The support of the arch wire is therefore not rigid but somehow resilient, which does not sufficiently develop the forces required for the rotation of a tooth.

From U.S. Pat. No. 6,142,776, a lingual orthodontic bracket is known whose slot is directed similarly as the slot in the bracket according to U.S. Pat. No. 5,863,199. For securing the arch wire, ligatures in the form of highly-resilient O-rings (usually made of rubber) are provided for this bracket, so that this bracket reveals similar disadvantages in use and when replacing the arch wire as the above-mentioned bracket. Moreover, the forces directed into the oral cavity, which originate from the arch wire, must be absorbed by the ligatures which easily yield to these forces.

Further lingual brackets are known from U.S. Pat. No. 4,455,137. In these brackets the slot on the side of the frame opposing the base plate is open, and the arch wire must be secured in the slot by ligatures so that this bracket reveals those disadvantages inherent to the two last mentioned brackets of U.S. Pat. No. 5,857,849 and 6 142 776. The same applies to brackets that are known from U.S. Pat. No. 4,337,037 and 4 669 981.

U.S. Pat. No. 5,516,284 describes a lingual orthodontic bracket, whose slot can be covered by a closing arrangement pivotally supported on the frame, said closing arrangement consisting of a sheet strip having a U-shaped bent section which is supported on the frame and whose two legs have unequal lengths and are bent again C-shaped. In the closing position, the shorter one of these C-shaped legs covers the slot, whereas the other C-shaped leg must be secured by means of a ligature on a horn formed on the frame. The overall frame of this bracket is relatively high and the opening of the slot is arranged on the side opposing the operator comparable to the bracket according to above-mentioned U.S. Pat. No. 5,863,199.

In orthodontics so-called self-ligating brackets have been started to use for a long time, in which the arch wire is secured in the slot of the bracket by a springy, pivotal element or a resiliently secured slide, compare e.g. U.S. Pat. No. 6,071,118 or EP 0 938 874 A2. Brackets of this type for labial applications have well been proven and tested in the past. However, satisfactory solutions have not been proposed for lingual applications. The reason for this is most of all that the space available for attaching the brackets is very small, and the distance of the brackets to one another, which is necessary that the arch wire can take effect, is very small. Thus, the brackets must be significantly smaller than the brackets for a labial application. On small brackets, however, the lever arm available for the arch wire for applying directional forces, particularly for rotation and torque, is very small.

U.S. Pat. No. 4,698,017 mentioned above describes a lingual bracket for orthodontic treatments of the incisors and canine teeth, said bracket comprising a base plate for the adhesive attachment on the lingual side of a tooth and having opposing occlusal and gingival edges, a frame elevated from the base plate, said frame having a slot extending substantially in parallel to the base plate for receiving an arch wire, and a means for securing an arch wire in said slot, wherein said slot is formed in the frame in a manner, that an imaginary slot plane extending through the bottom of the slot and the opposing slot opening and along the slot includes an acute angle with a plane determined by the base plate, and the slot opening opposing the apex of the angle essentially points in the direction of the occlusal edge of the base plate. This bracket, from which the present invention starts out, may be attached on the lingual side of a tooth, so that the plane defined by the bottom of the slot extends in parallel to the occlusal plane of the denture. The arch wire to be attached to the brackets is, thus, inserted into the slot perpendicularly with respect to the occlusal plane.

In the aforementioned bracket known from U.S. Pat. No. 4,698,017, the means for securing the arch wire within the slot consists of a strap which is pivotally connected to the bracket frame and which comprises a latching projection at its rear side which is adapted to be engaged from behind by a spring in the closed condition of the strap, said spring locking this strap against unintentional opening. A thin, arcuate spring strip is disposed on the slot bottom, said spring strip having a convex bulging directed to the slit opening. A spring wire is inserted into the slot and is secured by the securing strap and presses the bulging of said spring against the arch wire, so that the latter is pressed against the securing strap.

U.S. Pat. No. 5,474,545 discloses a labial bracket having a slot for receiving an arch wire, said slot opening in buccal direction and being more wide than deep. An arch wire of rectangular cross section is inserted on edge into said slot so that it totally fills the cross section of the slot and protrudes beyond the slot. It is secured within the slot by means of a pivotal strap hingedly secured to the bracket frame, said strap being displaced transversely with respect to its pivotal access after having been pivoted into the closing position, in order to positively fixing it to the bracket frame.

U.S. Pat. No. 6,168,428 shows a labial bracket having a slot for receiving an arch wire, said slot opening in buccal direction and being more deep than wide. An arch wire is inserted on edge into the slot, provided the arch wire has a rectangular cross section, and is secured within the slot by a closing slider which does not exert any forces onto the arch wire.

### SUMMARY OF THE INVENTION

The object of the invention is to provide a bracket of the above-mentioned type, into which the arch wire can be inserted in simple and time-saving manner, in which the arch wire is held safely and at which the arch wire can be effective in the best possible way.

This object is achieved by the features set forth in claims 1 and 4. Preferred embodiments of the invention are subject matter of the dependent claims. Arrangements for removing malalingnments of teeth by means of brackets of the kind of the invention are subject matter of claims 5 and 6.

The invention provides a bracket, in which the arch wire may be inserted into the slot from the occlusal side (chewing plane) in a safe manner. The insertion of the arch wire can therefore be easily supervised without using a mirror. Securing the arch wire in the slot is made by a spring, particularly by such a spring that can be pivoted in a manner known per se between two positions, wherein it exposes the slot in the one position and covers the slot in the other position. As an example, reference is made to U.S. Pat. No. 5,562,444. Alternatively, an elastic ligature may be used for securing the arch wire within the slot, said ligature being wound around the wings provided at the bracket frame and further extending over the arch wire und pressing same onto the bottom of the slot.

Due to the design of the bracket according to the invention, the rotational effect applied by the arch wire onto the bracket and therefore onto the treated tooth is not transferred by any resilient closing or holding mechanisms, such as springs or ligatures, but it is received unaffected by the bracket frame and is transferred therefrom onto the tooth. In the case of brackets for the application in the anterior and canine tooth area, the arch wires act on a plane that does not extend perpendicularly to the base face of the bracket but that extends substantially in parallel to the chewing plane. In this direction, the arch wire is not supported by the closing mechanism of the bracket, by i.e. the ligature or the spring, but by at least one side wall of the slot receiving the arch wire. Forces coming from the arch wire are therefore transferred better onto the tooth than is the case with known lingual brackets, so that when using lingual brackets, which are small compared to labial brackets, sufficiently great directional forces, particularly for rotation and torque, can be developed. Moreover, forces, which act onto the arch wire when chewing, such as biting off from an apple, act intensifying in a direction in which the arch wire is pressed onto the bottom of the slot.

It is self-evident that according to the differing inclinations of the lingual tooth surfaces, onto which the brackets are to be applied, the inclinations of the slot planes must be different compared to the surface defined by the base plate in order to achieve the goal on all central and lateral teeth stricken for by the invention. Slot plane in this case means a plane, which extends substantially perpendicularly with respect to the bottom of the slot. Accordingly, a set of brackets is required for an orthodontic treatment, which comprises different brackets designated for the different teeth in the anterior and canine tooth area. Brackets for the molars are, however, designed differently and are not subject matter of this invention.

The bracket according to the invention differs from all known lingual brackets in that the slot is open towards the chewing plane and is less deep than wide. An arch wire of rectangular cross section is therefore inserted into the slot with its broad side in a virtually flat manner, whereas in all known lingual brackets the arch wire is inserted into the slot with its narrow side, i.e. virtually on edge with respect to the slot.

In the bracket according to the invention, the ligature or the closing spring press the broad side of the arch wire onto the slot bottom in a direction, which depending on the malalignment of the tooth extends more or less perpendicular to the chewing plane. In the case of angular malalignment, forces are produced by the ligature or by the closing spring, which act in the sense of a correction of this malalignment. In the formerly known lingual brackets, the closing mechanisms cannot exert such resilient forces. In the bracket according to the invention, however, the arch wire is affected by the force of the ligature or the spring and is therefore effective on the tooth.

Furthermore, the arch wire contacts the ends of the slot at two diagonally opposing edges in a rotated tooth, and it applies pressure there so that the resiliency of the wire causes rotational forces at the bracket, which directly act on the bracket and which are therefore transferred onto the tooth. This is particularly important in the case of brackets for the anterior teeth of the lower jaw, since because of the small dimensions of the teeth, the brackets used there are very small and the leverage is very small. Resilient supports, such as by means of O-rings, as in the prior art, would significantly reduce the effect of the arch wire in this area and would often develop insufficient forces for correcting a rotation. This disadvantage is prevented by the invention.

A special advantage of the invention, which results from the position of the slot opening created by the invention is furthermore, that safety lugs for the free end of the closing spring, where such closing spring is used instead of a ligature, do not have to be used, and in the case of brackets for the upper anterior teeth and possibly the upper canine teeth these safety lugs are also advantageously not necessary. These brackets are therefore extremely flat, which is important to prevent that when closing the jaws, the lower anterior teeth gripping behind the upper anterior teeth hit the brackets fixed to the upper anterior teeth.

Such a safety lug is e.g. known from U.S. Pat. No. 4,492,573 and it is indispensable in the bracket shown there, since the opening and closing movements of the spring, which is U-shaped in this document and whose one leg covers the slot, extend transversely to the direction in which the arch wire would leave the slot. If the arch wire, for whatever reason, was urged out of the slot in the closing position of the spring, it would bend the spring excessively over its resiliency limit and would thereby destroy the entire bracket, if the free end of the spring leg covering the slot was not secured below a projecting lug. In the bracket according to the invention, an arch wire urged out of the slot in the opening direction of the closing spring acts on this spring and only pivots the spring without destroying it. The safety lug is therefore basically dispensable in this bracket. When it is still used, e.g. in the area of the canine teeth, it serves there on the one hand for enlarging the resistance against the arch wire being pressed out of the slot, and on the other hand the wire is released when a certain force is exceeded and thus, the tooth is automatically protected against overload. By this lug, the desired opening resistance of the spring can be produced.

Short Description of the Drawings

In the following, the invention is explained with reference to the drawings, wherein:

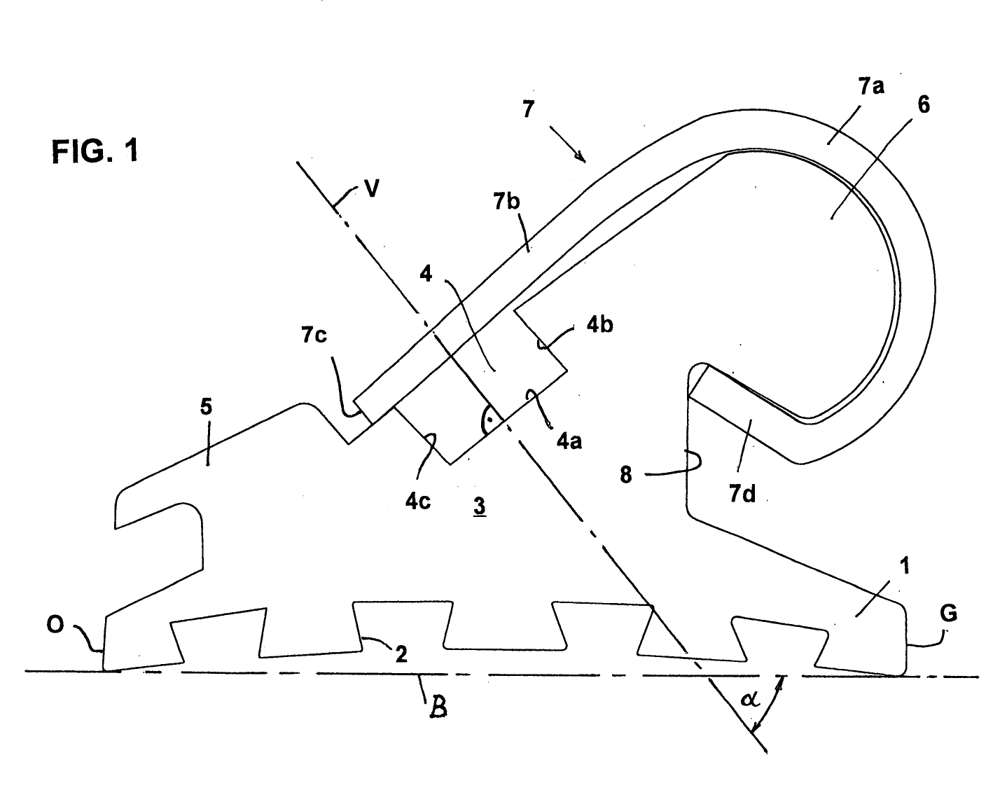

FIG. 1 is a side elevation view of a bracket according to the invention in the closed condition of the slot;

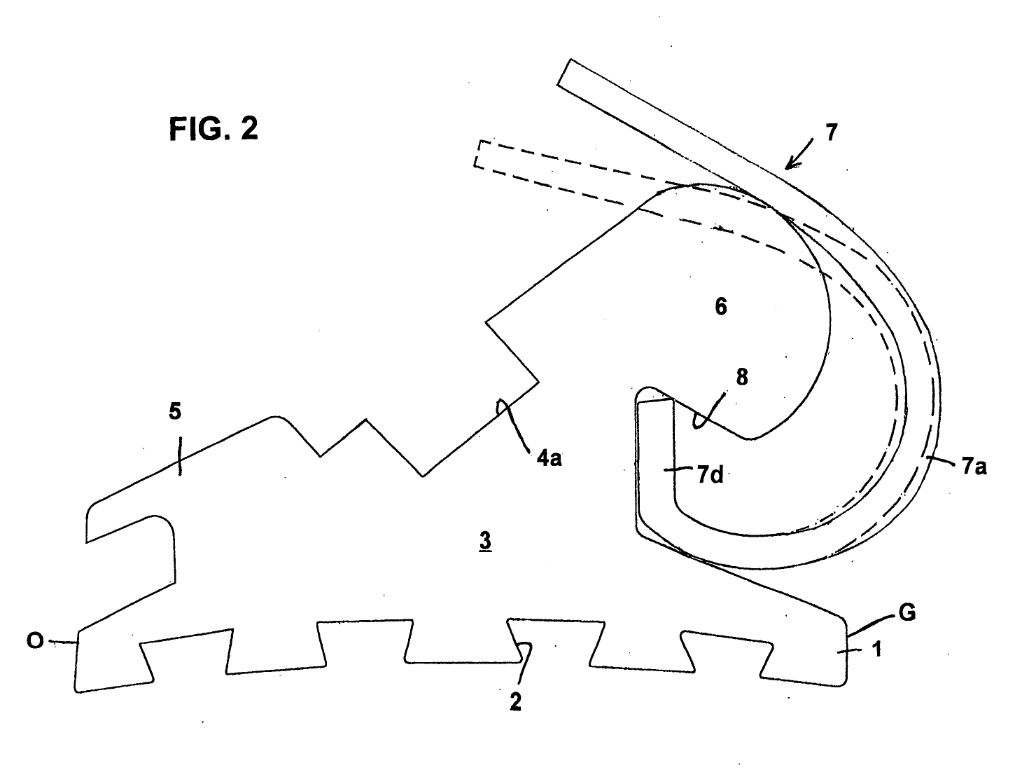

FIG. 2 shows the bracket of FIG. 1 in opened condition of the slot;

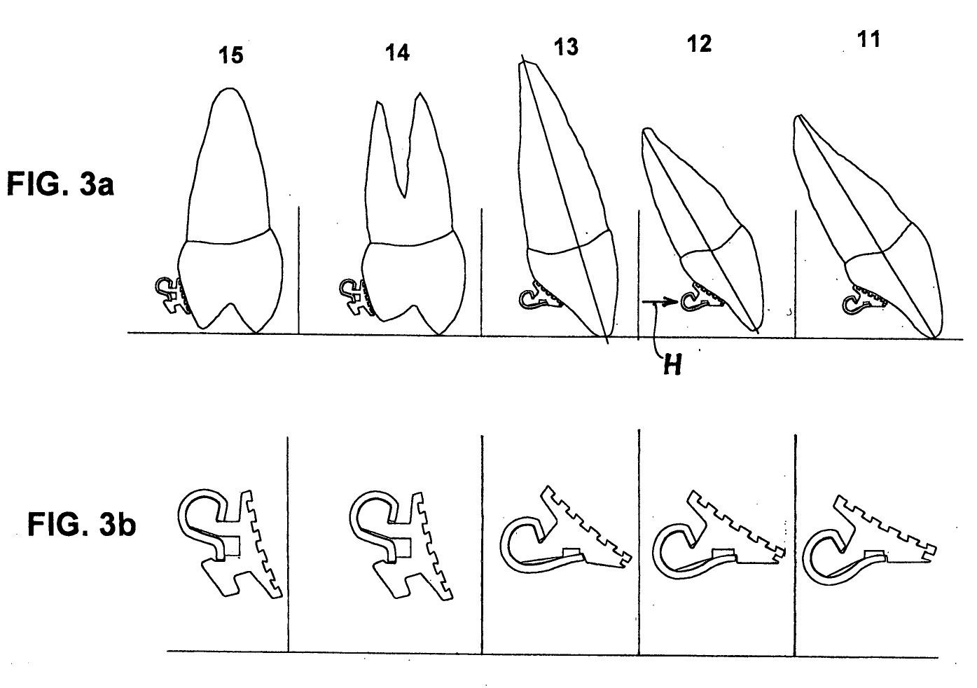

FIG. 3a shows various brackets in mounted condition on anterior teeth, canine teeth and molar teeth of an upper jaw;

FIG. 3b shows the brackets of FIG. 3a in a somewhat enlarged scale and in the same orientation as shown in FIG. 3a; and

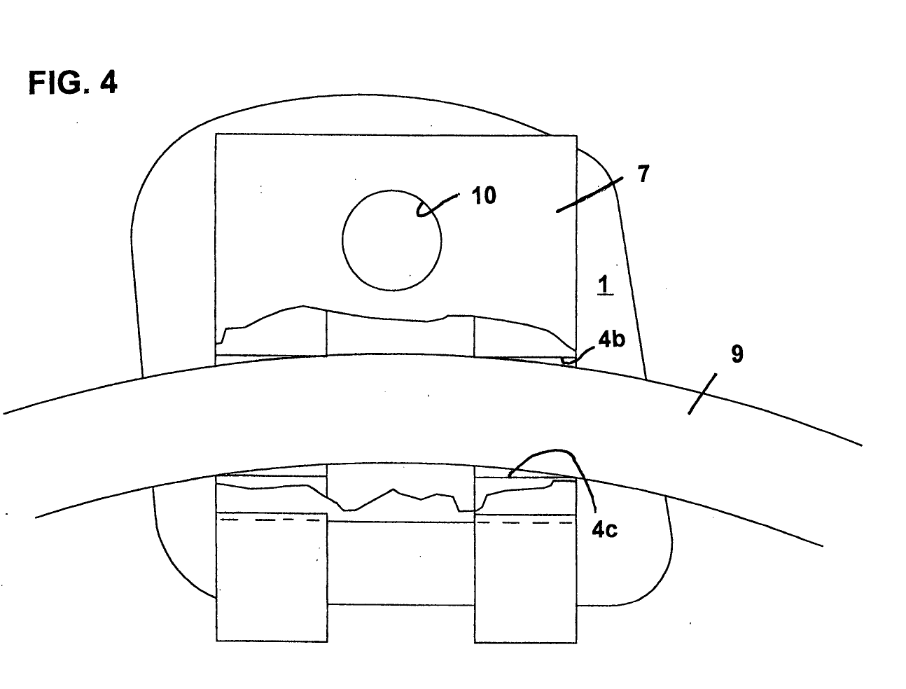

FIG. 4 shows a top plan view onto a bracket according to FIG. 1 with a closing spring partially broken away and an inserted arch wire;

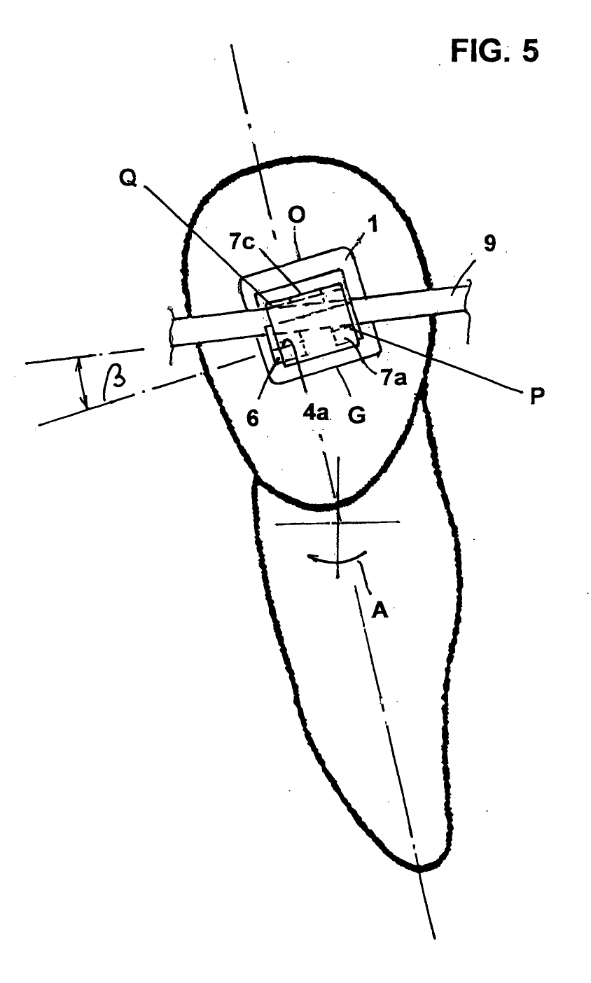

FIG. 5 shows a tooth with an oblique malalignment (angulation) with a bracket attached thereon of FIG. 1 in the line of vision H of FIG. 3a, tooth 12 to describe the angulational effect of the closing spring;

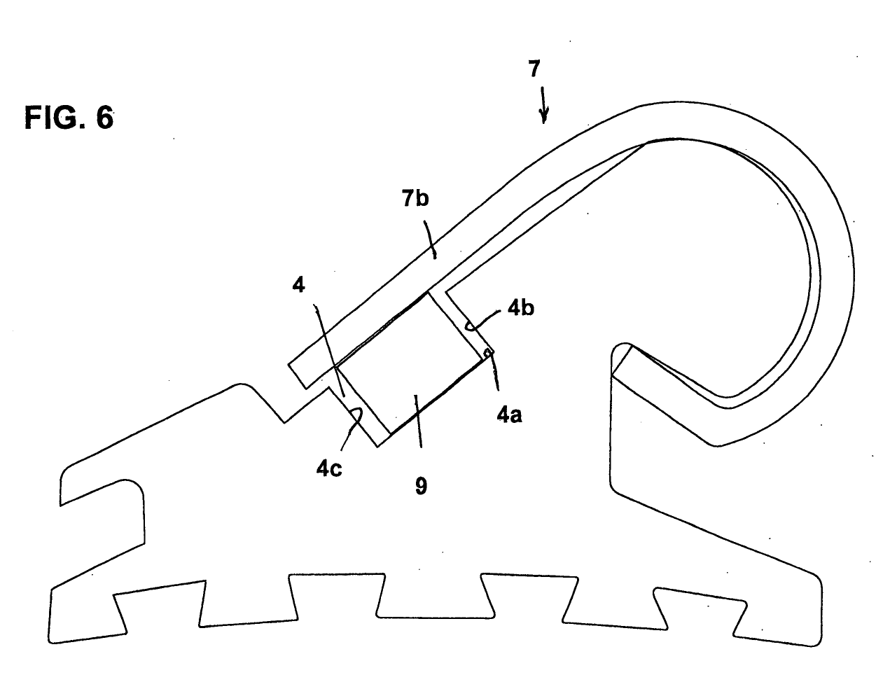

FIG. 6 shows a side elevation view of the bracket of FIG. 1 with an inserted arch wire;

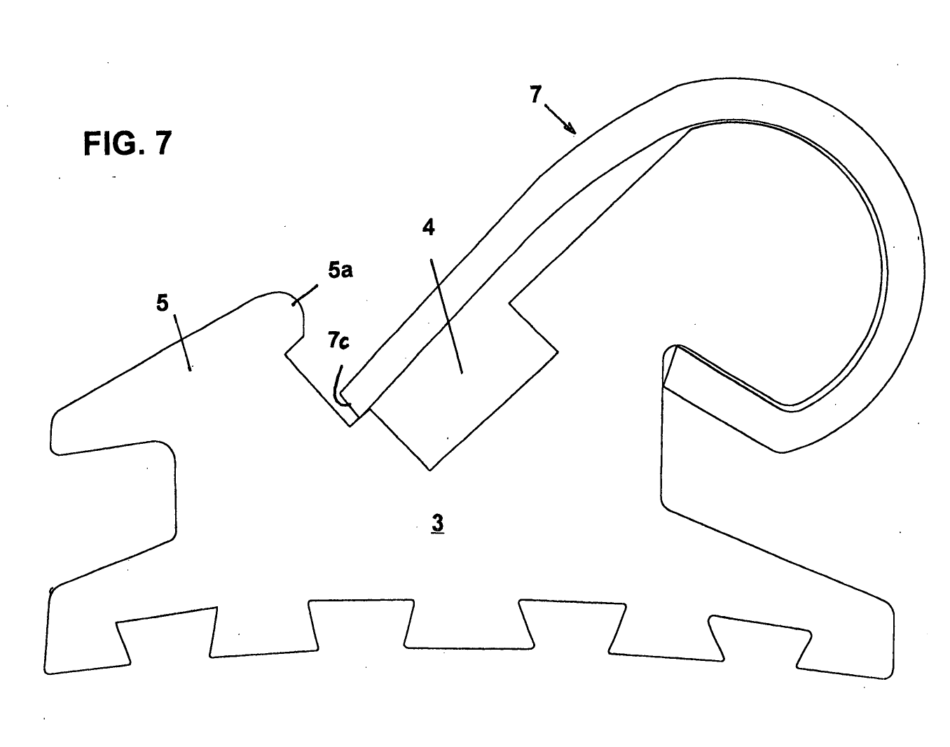

FIG. 7 shows a bracket similar to FIG. 1 with a projection over the free spring end, and

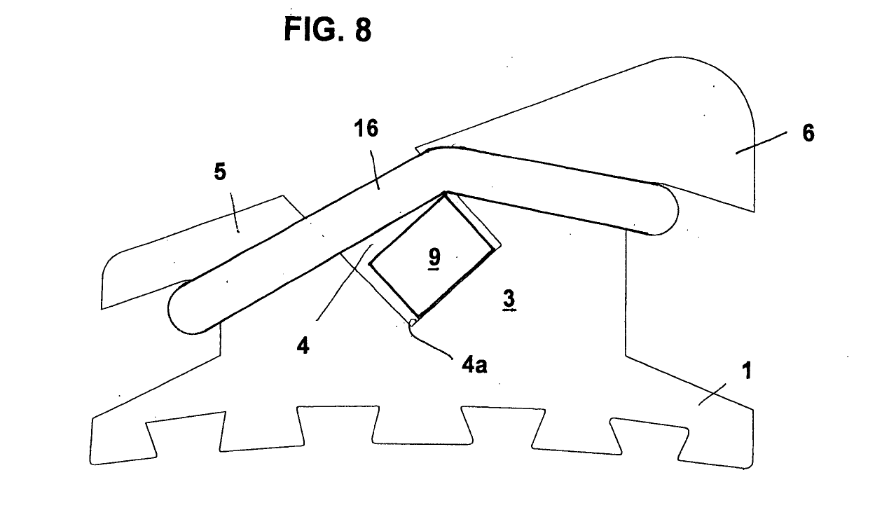

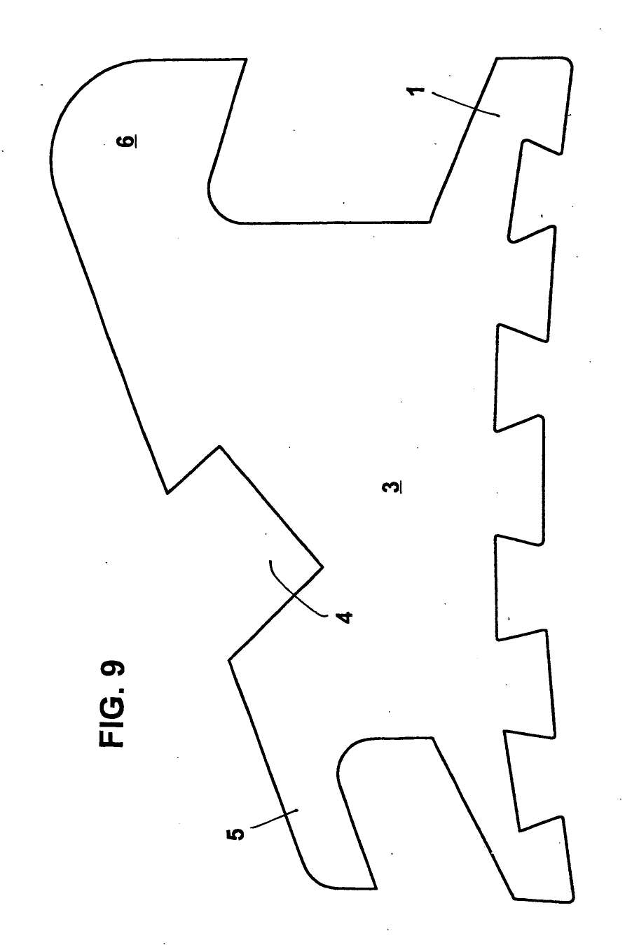

FIGS. 8 and 9 shows side elevation views of two brackets according to the invention for the use only with resilient ligatures.

### DESCRIPTION OF PREFERRED EMBODIMENTS

The bracket according to FIG. 1 consists of a base plate 1 with grooves 2 on its lower side, said grooves having a dovetail-shaped cross section, and of a frame 3 in which a slot 4 of a rectangular cross section is formed. In the example shown, the depth of this slot 4 is smaller than its width. The frame 3 has two wings 5 and 6, which adjoin to the side walls of the slot 4 and which can be used for attaching ligatures. The bracket further includes a spring designated by 7, in this case a leaf spring, which has an arcuate section 7a, which extends over an arc of approximately 270° and which changes over into an approximately straight section 7b, whose end portion covers the slot 54 in the closed condition, as shown in FIG. 1. The arcuate section 7a of the spring encompasses the wing 6 of the frame 3. The spring is held on the frame 3 by its own pre-tension in a state covering the slot 4. The spring 7 may also be a wire strap spring, as it is described in DE 44 07 100 C2.

As shown in FIG. 2, the spring 7 may be pivoted around the wing 6 from the state shown in FIG. 1 into a state releasing the slot 4. For this purpose, a notch 8 is formed below the wing 6 at the frame 6, within said notch the end portion 7d of the spring adjoining the arcuate section 7a can pivotally move. FIG. 2 shows in dotted lines how the spring would act if it could substantially relax. It can be seen at the solid lines that the spring in the open state shown in FIG. 2 is slightly bent open. In this state it secures itself in a clamping manner at the wing 6 of the bracket.

The grooves 2 serve for receiving glue or cement by means of which the bracket is attached to the tooth, wherein the dovetail shape of the cross section of the groove improves the adhesion of the glue or the cement.

Except for the dimensioning of the slot 4 and the flat overall get-up of the upper side of the bracket, the bracket shown is a conventional bracket.

The special properties of the bracket, which are decisive for the effects striven for by the invention, are determined by the fact that the slot 4 has such an alignment that an imaginary line perpendicularly directed on the slot bottom 4a extending in parallel to the longitudinal extension of the slot 4 and which is designated in FIG. 1 by V forms an acute angle α with a plane B determined by the base surface of the base plate, the apex of the angle pointing towards the gingival edge G of the base plate 1 so that the opening of the slot opposing the slot bottom 4a substantially points in the direction of the occlusal edge O of the base plate 1. The meaning of this measure becomes clear from FIG. 3a, in which a row of teeth consisting of one-type and two-type anterior teeth 11 and 12, canine tooth 13 and two molars 14 and 15 is schematically shown with brackets attached thereto.

It can be seen in FIG. 3a that the openings of the slots covered by the spring ends of the brackets attached to the anterior teeth 11 and 12 and the canine tooth 13 point in the same direction, namely in the direction of the chewing plane, as opposed to the slot planes of the brackets attached at the molars 14 and 15, which slot planes extend substantially in parallel to the chewing plane, as it is prior art. It can further be seen that the base surfaces of all bracket base plates, i.e. the planes B, have different inclinations with respect to the chewing plane, corresponding to the different inclinations of the lingual surfaces of the tooth crowns with respect to the chewing plane or a plane perpendicular thereto. Thus, different brackets are required for different teeth. In FIG. 3b this is shown in a slightly larger scale.

The angles that are included by the base surfaces of the bracket base plates with a perpendicular to the occlusal plane are e.g. in the bracket for the upper anterior teeth approx. 450, for the lower front teeth approx. 300 and for all four molars are approx. 35°. Thus, the inclination of said plane V of each bracket against the base plate plane B is also determined.

It can be seen from FIG. 3a that the insertion of an arch wire into the bracket slots on the anterior and canine teeth can very simply be observed from the chewing plane. If applied e.g. on the lower jaw, the arch wire can therefore simply be inserted and observed from the top into the bracket slots in the anterior and canine tooth area, and subsequently, the closing springs can reliably be closed over the arch wire lying in the slots.

It can further be seen that when biting into food, an arch wire inserted into the brackets cannot be pressed out of the slot caused by the pressure of the bitten food. It can further be seen that the forces caused by the arch wire at the tooth do not act at the closing spring for a rotation of the tooth but act at the lateral limitation walls of the bracket slots. The arch wire is therefore not supported at a resiliently yielding surface but at a rigid surface and does therefore not cause a better effect.

The latter becomes particularly clear from FIG. 4, which shows a bracket according to the invention with an arch wire 9 inserted into its slot 4, wherein the closing spring is partially broken away for better explaining the invention. One looks at the bracket in FIG. 4 from the chewing plane, i.e. onto the arc in which the arch wire 9 extends along the teeth of the row of teeth. It can clearly be seen in FIG. 3 that the arch wire 9 contacts the side walls 4b and 4c limiting the slot, and is rigidly supported by them, and that it may transfer its rotational forces for rotating the tooth around its axis and its torque forces for pivoting the tooth transversely to its axis directly onto the bracket.

The effect of the closing spring 7 in the sense of a correction of the angulation of the tooth can be seen from FIGS. 5 and 6. FIG. 5 shows a bracket, which is attached to a tooth, which has an angulational malalignment and which must be corrected transversely to its direction of the arrow drawn in dot and dash line in FIG. 5 in the direction of arrow A. FIG. 5 shows the view from the rear side of the tooth 12 in FIG. 3, i.e. seen in parallel to the chewing plane. In this malalignment, the arch wire 9 does not lie flat on the slot bottom 4a in the slot 4 of the bracket according to the invention but contacts the slot bottom 4a only on its mesial or distal end, depending on the malaligment of the tooth. This rest portion is characterized in FIG. 5 by P. Due to its inherent pre-tension, the spring 7 presses the arch wire 9 at position Q in the direction towards the slot bottom 4a.

Since the spring 7 is supported on the lower side of the wing 6 and exerts an upwardly directed force at this spring, but the arch wire cannot yield in the opposite direction, a force results therefrom which is exerted onto the tooth and rotates it around an axis extending perpendicularly to the tooth axis and slot extension in a direction that is designated in FIG. 5 by “A” (for angulational force). The tooth gradually erects itself so that the angle β that is included by the arch wire 9 with the slot bottom 4a in the direction of the longitudinal extension of the slot 4, becomes gradually smaller until the arch wire 9 at the end of the treatment rests flatly on the slot bottom, in the ideal case.

It can be seen from FIG. 6 that the slot can be kept relatively “flat”, i.e. it may be less deep than wide so that an arch wire 9, even if it does not fill the slot in its entire width, i.e. an arch wire 9 of small cross dimensions of the above-mentioned arch wire “family”, projects over the slot opening and is loaded by force from the closing spring 7 (or by a ligature wound at the position of the closing spring around the wings 5 and 6). The small slot depth allows to design the bracket in a very low manner.

It is also remarkable in the bracket according to the invention that only rounded elements, namely the arcuate portion of the closing spring, are exposed in the lingual direction, which minimizes inconvenience to the patient by the brackets.

FIG. 7 shows a second embodiment of a bracket according to the invention, which differs from the bracket according to FIG. 1 in that it has a lug-like projection 5a on the wing 5, said projection extending over the free end 7c of the closing spring 7. It prevents the spring 7 from immediately yielding to a pressure in the opening direction coming from the arch wire. It is dimensioned such that the spring 7 may yield when a certain limit value is reached. Thus, the forces that may act on the tooth are limited, whereby the tooth is again protected against overload. The forces are similar to the forces applied by the orthodontist onto the closing spring when opening and closing the closing spring 7 by using an instrument inserted into an opening 10 (see FIG. 4) of the closing spring 7, for instance a hook. This bracket can e.g. be used on the canine teeth where an extremely flat structural shape of the bracket is less relevant.

Finally, FIG. 8 shows a side elevation view of a bracket according to the invention, which does not comprise a slot for securing the arch wire in the slot 4 and which must therefore only be used in combination with a resilient ligature, e.g. in the form of a rubber O-ring 16 of a known kind, which is wound over the arch wire 9 and the wings 5 and 6 and which holds the arch wire in the slot 4 and presses it onto the slot bottom 4a. Even if the depth of the slot 4 is larger that its width in this embodiment, the alignment of the slot 4 is as in the previously described embodiments such that an arch wire 9 of rectangular cross sectional dimensions, as shown in this case, is laid onto the slot bottom 4a in a “flat” manner, i.e. with its broader side, to finally be secured with the ligature 16.

The same applies with respect to the position of the arch wire in the slot 4 and the fastening of same therein in the embodiment according to FIG. 9, which shows a bracket, whose slot is less deep than wide, as in the embodiment according to FIG. 1.

1. A lingual bracket for orthodontic treatments of the anterior and canine teeth, comprising a base plate (1) for the adhesive attachment on the lingual side of a tooth and having opposing occlusal and gingival edges (O, G), a frame (3) elevated from the base plate (1), said frame having a slot (4) extending substantially in parallel to the base plate (1) for receiving an arch wire (9), and a means (7; 16) for securing an arch wire (9) in this slot (4), wherein the slot (4) is formed in the frame (3) in a manner that an imaginary slot plane (V) extending through the bottom (4a) of the slot and the opposing slot opening and along the slot (4) includes and acute angle (α) with a plane (B) determined by the base plate (1), and the slot opening opposing the apex of the angle (a) essentially points in the direction of the occlusal edge (O) of the base plate (1), characterized in that the slot (4) has a depth that is smaller than its width, and the securing means is formed by a leaf spring or wire strap spring (7) which is anchored on the frame (3) and which covers the slot (4) in a closing position.

2. A bracket as claimed in claim 1, characterized in that the leaf spring or wire strap spring. (7) comprises a portion (7a) which describes an arc of approximately 270°, which resiliently clampingly engages a wing (6) of the frame (3) and which further comprises an approximately straight extension (7b), and that the leaf or wire strap spring (7) is pivotal between two end positions in whose one position the slot (4) is open and in whose other position the slot (4) is covered by a straight extension (7b), wherein the leaf spring (7) is stably held in both end positions by resilient clamping of the arcuate section (7a) at the wing (6).

3. A bracket as claimed in claim 2, characterized in that the free end (7c) of the extension (7b) of the leaf spring (7) is covered by a projection (5a) at the frame (3) in the position covering the slot (4).

4. A lingual bracket for orthodontic treatments of the anterior and canine teeth, comprising a base plate (1) for the adhesive attachment on the lingual side of a tooth and having opposing occlusal and gingival edges (O, G), a frame (3) elevated from the base plate (1), said frame having a slot (4) extending substantially in parallel to the base plate (1) for receiving an arch wire (9), and a means (7; 16) for securing an arch wire (9) in this slot (4), wherein the slot (4) is formed in the frame (3) in a manner that an imaginary slot plane (V) extending through the bottom (4a) of the slot and the opposing slot opening and along the slot (4) includes and acute angle (a) with a plane (B) determined by the base plate (1), and the slot opening opposing the apex of the angle (a) essentially points in the direction of the occlusal edge (O) of the base plate (1), characterized in that the slot (4) has a depth that is smaller than its width, and that the securing means comprise wings (5,6) formed at said frame (3), said wings being adapted to be looped by a resilient ligature (16) extending above the arch wire (9) disposed in said slot (4) and pressing said arch wire 4) onto the bottom of said slot.

5. Arrangement for removing malalignments of a denture, comprising
a lingual bracket for the orthodontic treatment of the anterior and canine teeth, comprising a base plate (1) for the adhesive attachment on the lingual side of a tooth and having opposing occlusal and gingival edges (O, G), a frame (3) elevated from the base plate (1), said frame having a slot (4) extending substantially in parallel to the base plate (1) for receiving an arch wire (9), and a means (7; 16) for securing an arch wire (9) in this slot (4), wherein the slot (4) is formed in the frame (3) in a manner that an imaginary slot plane (V) extending through the bottom (4a) of the slot and the opposing slot opening and along the slot (4) includes and acute angle (a) with a plane (B) determined by the base plate (1), and the slot opening opposing the apex of the angle (a) essentially points in the direction of the occlusal edge (O) of the base plate (1), and an arch wire (9), which is disposed in said slot (4),
characterized in that
said slot (4) has a depth that is smaller than its width, said arch wire (9) has a rectangular cross section having a wide side and a narrow side, said arch wire (9) is inserted flat with its wide side into said slot, and the securing means is formed by a leaf spring or wire strap spring (7) which is anchored on the frame (3) and which in a closing position thereof presses onto a wide side of the arch wire (9) disposed in said slot (4).

6. Arrangement for removing malalignments of a denture, comprising
a lingual bracket for the orthodontic treatment of the anterior and canine teeth, comprising a base plate (1) for the adhesive attachment on the lingual side of a tooth and having opposing occlusal and gingival edges (O, G), a frame (3) elevated from the base plate (1), said frame having a slot (4) extending substantially in parallel to the base plate (1) for receiving an arch wire (9), and a means (7; 16) for securing an arch wire (9) in this slot (4), wherein the slot (4) is formed in the frame (3) in a manner that an imaginary slot plane (V) extending through the bottom (4a) of the slot and the opposing slot opening and along the slot (4) includes and acute angle (α) with a plane (B) determined by the base plate (1), and the slot opening opposing the apex of the angle (a) essentially points in the direction of the occlusal edge (O) of the base plate (1), and an arch wire (9), which is disposed in said slot (4),
characterized in that
said slot (4) has a depth that is smaller than its width, said arch wire (9) has a rectangular cross section having a wide side and a narrow side, said arch wire (9) is inserted flat with its wide side into said slot, and the securing means comprise wings (5,6) formed at said frame (3), said wings being adapted to be looped by a resilient ligature (16) extending above the arch wire (9) disposed in said slot (4) and pressing said arch wire 4) onto the bottom of said slot.
